(19) United States
(12) Patent Application Publication
(10) Pub. No.: US 2013/0219021 A1
(43) Pub. Date: Aug. 22, 2013

(54) PREDICTIVE CACHING FOR TELECOMMUNICATION TOWERS USING PROPAGATION OF IDENTIFICATION OF ITEMS OF HIGH DEMAND DATA AT A GEOGRAPHIC LEVEL

(71) Applicants: Arup Acharya, Nanuet, NY (US); Anthony J. Allegri, Roswell, GA (US); John R. Dingler, Dallas, GA (US); Sri Ramanathan, Lutz, FL (US); Matthew A. Terry, Dunwoody, GA (US); Matthew B. Trevathan, Kennesaw, GA (US)

(72) Inventors: Arup Acharya, Nanuet, NY (US); Anthony J. Allegri, Roswell, GA (US); John R. Dingler, Dallas, GA (US); Sri Ramanathan, Lutz, FL (US); Matthew A. Terry, Dunwoody, GA (US); Matthew B. Trevathan, Kennesaw, GA (US)

(73) Assignee: INTERNATIONAL BUSINESS MACHINES CORPORATION, Armonk, NY (US)

(21) Appl. No.: 13/397,792

(22) Filed: Feb. 16, 2012

(51) Int. Cl. G06F 15/16

(52) U.S. Cl. 709/219

(57) ABSTRACT

Method, computer program product and computer system for predictive caching for telecommunication towers having associated local servers, using propagation of identification of items of high demand data at a geographic level comprising the steps of: receiving within a region at least one request for an item of data made by a user device to a local server associated with a telecommunication tower within the region; and determining if the request is for an item of high demand data. If the item is identified as high threshold data, instructing the local servers within the region to cache the item of data; and if the item is identified as second threshold high demand data, sending an indication to at least one centralized server in an adjacent region, such that the centralized server in the adjacent region causes the local servers within the adjacent region to cache the item of data.

### BACKGROUND

The present invention relates to predictive caching for telecommunication towers having associated local servers, and more specifically to predictive caching for telecommunication towers using propagation of identification of items of high demand data at a regional or other geographic level.

With the increase in use of smart phones and other such devices that access the Internet, telecommunication service providers have encountered challenges in providing sufficient data access due to network access limitations.

One limitation is the data connection speed between a wireless telecommunication tower and the user's device. Telecommunication service providers are currently addressing this limitation by investing in higher speed transmission protocols.

Another limitation is the connection between the Internet and the wireless telecommunication tower being limited by the amount of bandwidth available and network throughput. Currently, the telecommunication service providers are attempting to address these problems by expanding their networks through the addition of new wireless telecommunication towers and increasing the bandwidth of the wireless telecommunication towers. However, these solutions are costly and will not be able to maintained long term.

### SUMMARY

According to one embodiment of the present invention, a method for predictive caching for telecommunication towers having associated local servers, using propagation of identification of items of high demand data at a regional or other geographic level. The method comprising the steps of: a computer within a region receiving at least one request for an item of data made by a user device to a local server associated with a telecommunication tower within the region; the computer determining if the request is for an item of high demand data by the steps of: comparing a number of requests for the item to a first threshold and to a second threshold greater than the first threshold; if the number of requests for the item requested by the user device exceeds the first threshold, identifying the item as high demand data; and if the number of requests for the item requested by the user device exceeds the second threshold, identifying the item as second threshold high demand data. If the item is identified as high threshold data, instructing the local servers within the region to cache the item of data; and if the item is identified as second threshold high demand data, sending an indication to at least one centralized server in an adjacent region, such that the centralized server in the adjacent region causes the local servers within the adjacent region to cache the item of data.

According to another embodiment of the present invention, a computer program product for predictive caching for telecommunication towers having associated local servers, using propagation of identification of items of high demand data at a regional or other geographic level. The computer program product comprising: one or more computer-readable, tangible storage devices; program instructions, stored on at least one of the one or more storage devices, to receive at least one request within a region for an item of data made by a user device to a local server associated with a telecommunication tower within the region; program instructions, stored on at least one of the one or more storage devices, to determine if the request is for an item of high demand data comprising program instructions to compare a number of requests for the item to a first threshold and to a second threshold greater than the first threshold; if the number of requests for the item requested by the user device exceeds the first threshold, program instructions to identify the item as high demand data; and if the number of requests for the item requested by the user device exceeds the second threshold, program instructions to identify the item as second threshold high demand data. If the item is identified as high threshold data, program instructions, stored on at least one of the one or more storage devices, to instruct the local servers within the region to cache the item of data; and if the item is identified as second threshold high demand data, program instructions, stored on at least one of the one or more storage devices, to send an indication to at least one centralized server in an adjacent region, such that the centralized server in the adjacent region causes the local servers within the adjacent region to cache the item of data.

According to another embodiment, a computer system for predictive caching for telecommunication towers having associated local servers, using propagation of identification of items of high demand data at a regional or other geographic level. The computer system comprising: one or more processors, one or more compute-readable memories and one or more computer-readable, tangible storage devices; program instructions, stored on at least one of the one or more storage devices for execution by at least one of the one or more professors via at least one of the one or more memories, to receive at least one request within a region for an item of data made by a user device to a local server associated with a telecommunication tower within the region; program instructions, stored on at least one of the one or more storage devices for execution by at least one of the one or more professors via at least one of the one or more memories, to determine if the request is for an item of high demand data comprising program instructions to compare a number of requests for the item to a first threshold and to a second threshold greater than the first threshold; if the number of requests for the item requested by the user device exceeds the first threshold, program instructions to identify the item as high demand data; and if the number of requests for the item requested by the user device exceeds the second threshold, program instructions to identify the item as second threshold high demand data. If the item is identified as high threshold data, program instructions, stored on at least one of the one or more storage devices for execution by at least one of the one or more professors via at least one of the one or more memories, to instruct the local servers within the region to cache the item of data; and if the item is identified as second threshold high demand data, program instructions, stored on at least one of the one or more storage devices for execution by at least one of the one or more professors via at least one of the one or more memories, to send an indication to at least one centralized server in an adjacent region, such that the centralized server in the adjacent region causes the local servers within the adjacent region to cache the item of data.

### BRIEF DESCRIPTION OF THE SEVERAL VIEWS OF THE DRAWINGS

FIG. 1 depicts a pictorial representation of a network of computers in which illustrative embodiments may be implemented

FIG. 2 shows an example of a prior art telecommunication system.

FIG. 3 shows a telecommunication system of an embodiment of the present invention.

FIG. 4 shows a method of predictive caching for servers at telecommunication towers, using identification of high demand data requests which are propagated at a regional or other geographic level.

FIG. 5 shows illustrates internal and external components of a client computer and a server computer in which illustrative embodiments may be implemented

### DETAILED DESCRIPTION

It will be understood that as used herein, the term “telecommunications tower” means a wireless telecommunications site, including the physical tower and antennas as well as all supporting radio transmission equipment, digital servers, communications equipment for connection to digital and/or analog networks, etc.

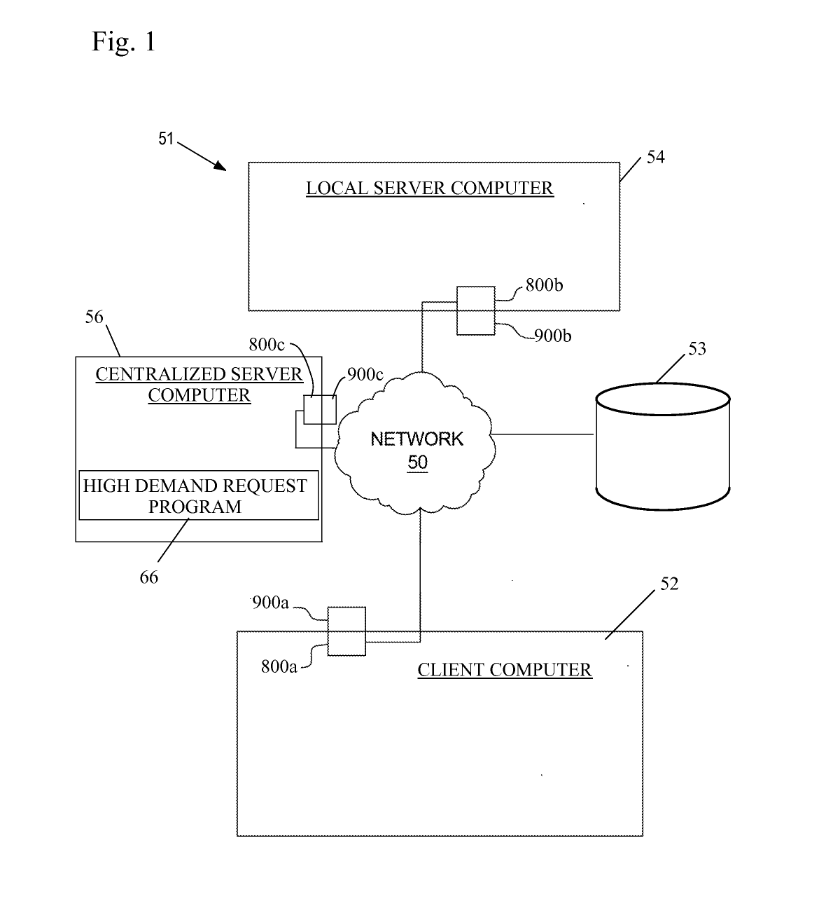

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

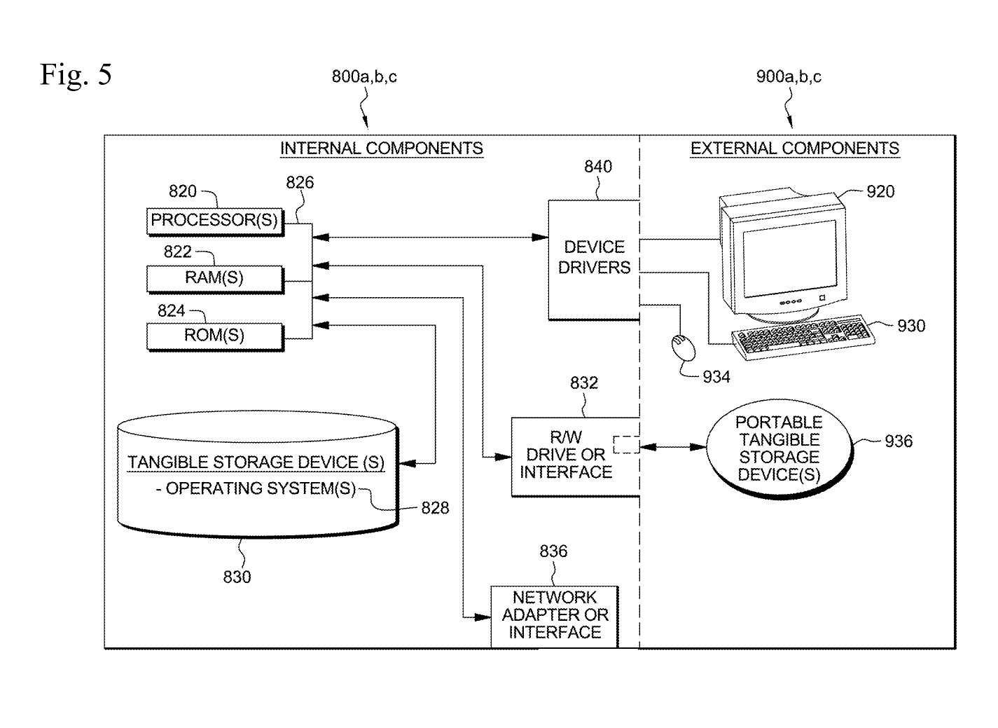

In the depicted example, client computer 52, tangible storage device 53, centralized server computer 56 and local server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 5. Client computer 52 may be, for example, a mobile device, a cell phone, a personal digital assistant, a netbook, a laptop computer, a tablet computer, a desktop computer, or any other type of computing device. Client computer 52, local server computer 54, and centralized server computer 56 may each contain an interface, which can be, for example, a command line interface, a graphical user interface (GUI), or a web user interface (WUI) through which an administrator or other such user can access a network including high demand request program 66 on the centralized server computer 56. The local server computer 54 and the centralized server computer 56 each include a set of internal components 800b, 800c and a set of external components 900b, 900c illustrated in FIG. 5.

In the depicted example, the local server computer 54 and the centralized server computer 56 could provide information, such as boot files, operating system images, and applications to a client computer 52. The centralized server computer 56 and the local server computer 54 can compute the information locally or extract the information from other computers on network 50.

Program code and programs such as a high demand request program 66 may also be located in network data processing system 51 and may be stored on at least one of one or more computer-readable tangible storage devices 830 shown in FIG. 5, on at least one of one or more portable computer-readable tangible storage devices 936 as shown in FIG. 5, on tangible storage device 53 connected to network 50, or downloaded to a data processing system or other device for use. For example, program code and programs such as a high demand request program 66 may be stored on at least one of one or more tangible storage devices 830 on the centralized server computer 56. Alternatively, the centralized server computer 56 can be a web server, and the program code, and programs such as an a high demand request program 66 may be stored on at least one of the one or more tangible storage devices 830 on centralized server computer 56 and accessed on the local server computer 54. In other exemplary embodiments, the program code, and programs such as a high demand request program 66 may be distributed between two or more servers.

In the depicted example, network data processing system 51 is a combination of a number of computers and servers, with network 50 representing the Internet—a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

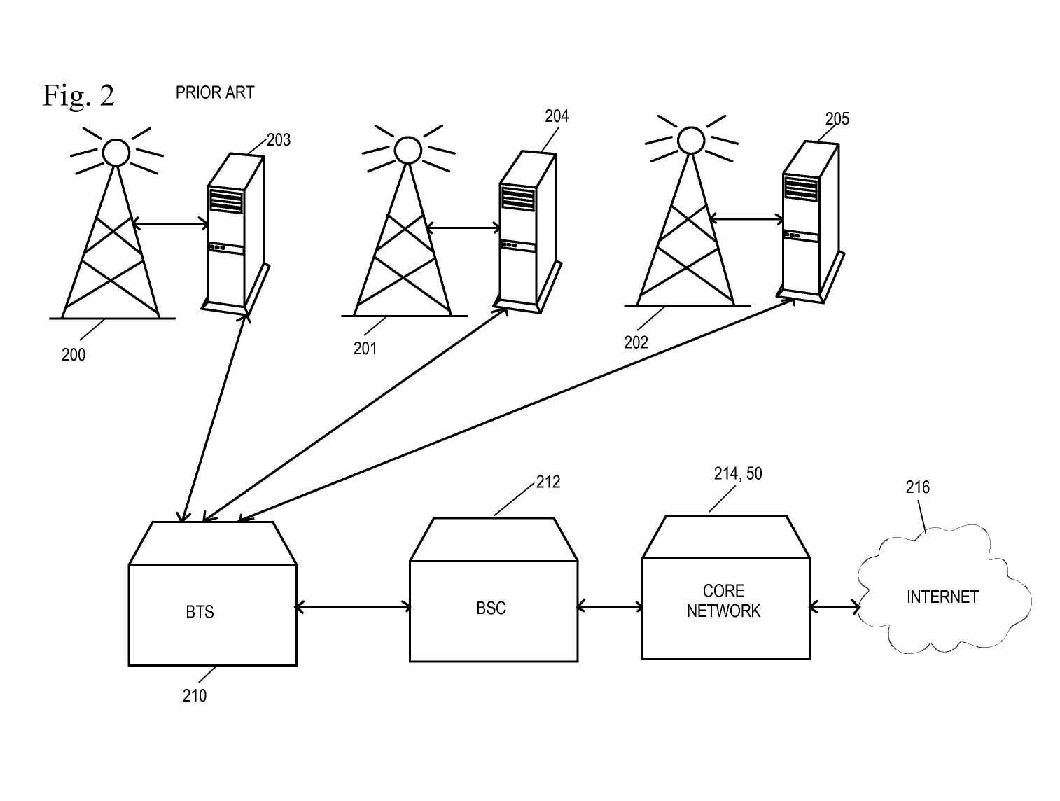

FIG. 2 shows a prior art telecommunication system. Wireless telecommunication towers (and their associated radio and other equipment) 200, 201, 202 within a geographic region each have local servers 203, 204, 205, which may be for example edge side cache servers. All data content that was requested by a user device passes between the wireless telecommunication towers 200, 201, 202 and the Internet 216 is cached within the local server 203, 204, 205.

Therefore, if a data request was made by a user device, the wireless telecommunication tower 200, 201, 202 closest to the user device would check its local server 203, 204, 205 for the data content requested. If the data content requested is not present, the data request is sent to the base transceiver station (BTS) 210. The BTS 210 converts the data content request to a signal and sends the converted signal to the base station controller (BSC) 212. The BSC 212 converts the data content request to packets and sends the request to a core network 214, for example a general packet radio system (GPRS) core network, or another network, such as network 50. The core network 214 is connected to the Internet 216 to obtain the data content requested. The data content requested is obtained from the Internet 216, and sent through the core network 214 to the base station controller (BSC) 212 and to the base station transceiver station (BTS) 210, where the data content requested is then sent back to the appropriate local server 203 or 204 or 205 and individual wireless telecommunication tower 200 or 201 or 202 in which the data was requested by the user device. From the individual wireless telecommunication tower 200 or 201 or 202, a signal is sent to the user device that originally made the request. The data content may also be cached at the local server connected to the individual wireless telecommunication tower from which the data content was requested by the user device. Therefore, each individual wireless telecommunication tower maintains its own local cache of data content.

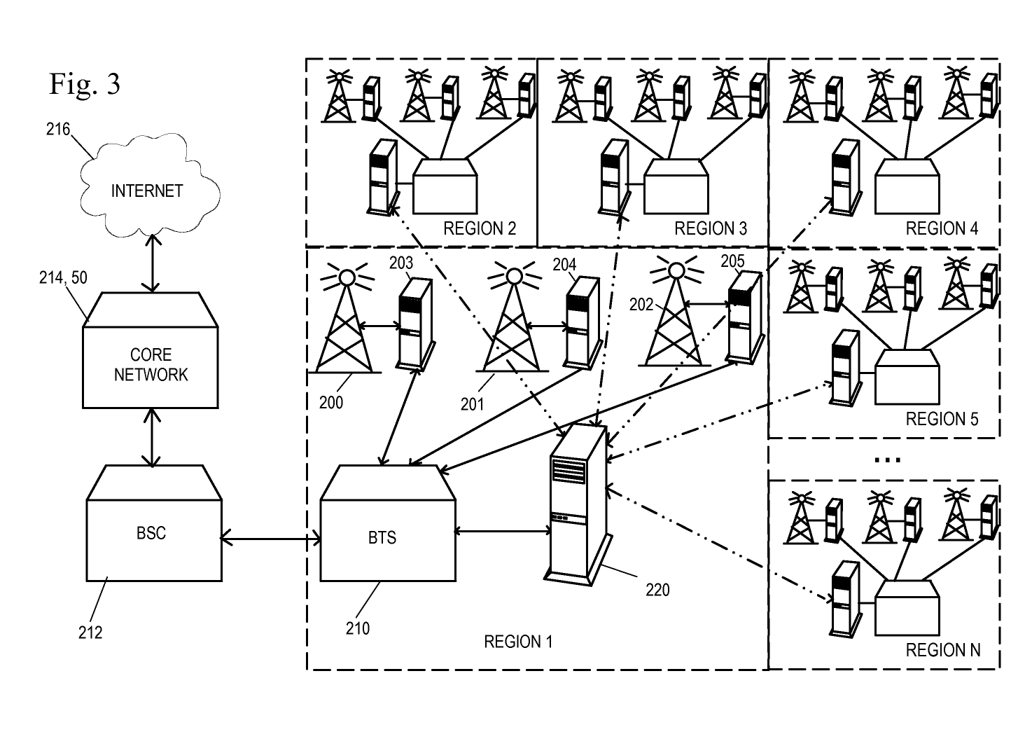

FIG. 3 shows a telecommunication system of an embodiment of the present invention. Each geographic region (region 1 through region N) includes wireless telecommunication towers 200, 201, 202 each with local servers 203, 204, 205, which may be for example edge side cache servers, a BTS 210 and a centralized server 220. The centralized server 220 (which may be centralized server 56 shown in FIG. 1) includes a high demand request program (66 in FIG. 1). Each of the local servers 203, 204, 205 is in communication with a BTS 210. The BTS 210 is in communication with a regional centralized server 220.

The high demand request program 66 may be configured to include a first threshold of the number of times a specific item of data content is requested and a second threshold of the number of times that item of data content is requested. The second threshold is greater than the first threshold.

It should be noted that while the figure shows the local servers 203, 204, 205 directly connected to the BTS 210 and the BTS connected to the regional centralized server 220, the local servers 203, 204, 205 may also be directly connected to the regional centralized server 220.

Each BTS 210 sends and receives data from a BSC 212, which in turn sends and receives data from a core network 214, for example a general packet radio system (GPRS) core network, or another network, such as network 50. The core network 214 receives data from the Internet 216 and sends the data content back to wireless telecommunication towers 200, 201, 202 through the BSC 212 and the BTS 210.

The regional centralized servers 220 are also in communication with other nearby regional centralized servers 220, through the BTS 210, for example as shown in FIG. 3, the centralized server 220 of Region 1 is connected to the centralized server of adjoining regions 2, 3, 4, 5 . . . N.

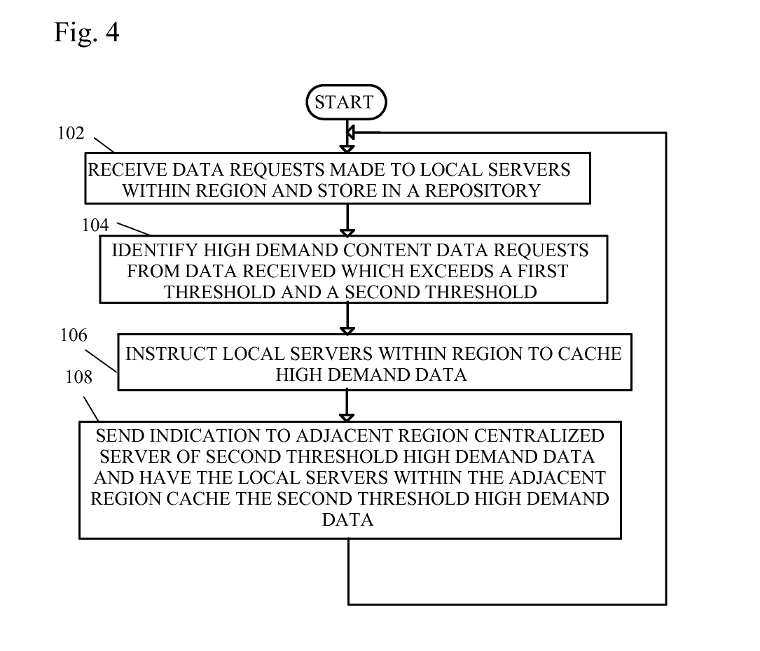

FIG. 4 shows a method of predictive caching for servers at telecommunication towers, using identification of high demand data requests which are propagated at a regional or other geographic level. The method may be applied to the telecommunication system of FIG. 3.

A centralized server 220 receives data requests made to one of the local servers 203, 204, 205 by a user device (not shown) through the wireless telecommunication towers 201, 202, 203 within the region. The server stores the data requests in a repository (step 102), such as one of one or more computer-readable tangible storage devices (830 in FIG. 5), on at least one of one or more portable computer-readable tangible storage devices (936 in FIG. 5), or on tangible storage device 53 connected to network 50 as shown in FIG. 1.

When a request is made by a user device for an item of data such as a file, image, video, etc., the regional centralized server 220 checks to see if the number of requests for the item exceed a first threshold and a second threshold (step 104), with the second threshold being greater than the first threshold. If the number of requests exceed the first threshold, the item is identified as “high demand data”, and if the number of requests exceeds the second, higher, threshold, the item is further identified as “second threshold high demand data”.

The regional centralized server 220 instructs the local servers 203, 204, 205 within its region to cache high demand data content (step 106). For second threshold high demand data, the regional centralized server 220 sends an indication to adjacent regional centralized servers, so that they will cache the second threshold high demand data and also have the local servers within their region cache the second threshold high demand data (step 108). The centralized server of the original region would then repeat steps 102-108. It should be noted that the centralized servers 220 of the other Regions 2, 3, 4, 5, . . . N would also be carrying out steps 102-108 at the same time as the centralized server 220 of Region 1.

The length of time in which a second threshold high demand data is cached or the cache life span of a second threshold high demand data item may be dependent upon request frequency by user devices. Once the request frequency decreases below a defined parameter, the cached item may be purged from the servers.

By sending the second threshold high demand data content to the adjacent regions and having the local servers in the adjacent regions cache such data in advance, the likelihood that a request by a user device in the adjacent area would request data which is cached is increased. Thus, the amount of data that needs to requested through the core network and the Internet is decreased and the data content will be readily available when requested by any user device.

FIG. 5 illustrates internal and external components of client computer 52, a centralized server computer 56 and a local server computer 54 in which illustrative embodiments may be implemented. In FIG. 5, client computer 52, centralized server computer 56 and local server computer 54 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and high demand request program 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. A high demand request program 66 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. A high demand request program 66 can be downloaded to computer 52 and server computer 54 from an external computer via a network (for example, the Internet, a local area network or other, wide area network) and network adapter or interface 836. From the network adapter or interface 836, a search results program 66 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 940. Each of the sets of internal components 800a, 800b, 800c also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

A high demand request program 66 can be written in various programming languages including low-level, high-level, object-oriented or non object-oriented languages. Alternatively, the functions of a high demand request program 66 can be implemented in whole or in part by computer circuits and other hardware (not shown).

Based on the foregoing, a computer system, method and program product have been disclosed for predictive caching for telecommunication towers having associated local servers, using propagation of identification of items of high demand data at a regional or other geographic level. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for predictive caching for telecommunication towers having associated local servers, using propagation of identification of items of high demand data at a regional or other geographic level, comprising the steps of:
a computer within a region receiving at least one request for an item of data made by a user device to a local server associated with a telecommunication tower within the region;
the computer determining if the request is for an item of high demand data by the steps of:
comparing a number of requests for the item to a first threshold and to a second threshold greater than the first threshold;
if the number of requests for the item requested by the user device exceeds the first threshold, identifying the item as high demand data; and
if the number of requests for the item requested by the user device exceeds the second threshold, identifying the item as second threshold high demand data;
if the item is identified as high threshold data, instructing the local servers within the region to cache the item of data; and
if the item is identified as second threshold high demand data, sending an indication to at least one centralized server in an adjacent region, such that the centralized server in the adjacent region causes the local servers within the adjacent region to cache the item of data.

2. The method of claim 1, in which the step of sending an indication to at least one centralized server in an adjacent region comprises sending an indication to at least one centralized server in all adjacent regions.

3. The method of claim 1, wherein the item is a file, image or video.

4. The method of claim 1, wherein the computer is a centralized server.

5. The method of claim 1, wherein the item identified as second threshold high demand data has a cache life span dependent on a number of requests for the item by user devices.

6. The method of claim 1, wherein if requests for an item of data identified as second threshold demand data is below a determined number, the item of data identified as second threshold demand data is purged from the local servers.

7. A computer program product comprising one or more computer-readable, tangible storage devices and computer-readable program instructions which are stored on the one or more storage devices and when executed by one or more processors, implement all the steps of claim 1.

8. A computer system comprising one or more processors, one or more computer-readable memories, one or more computer-readable, tangible storage devices and program instructions which are stored on the one or more storage devices for execution by the one or more processors via the one or more memories and when executed by the one or more processors implement all the steps of claim 1.

9. A computer program product for predictive caching for telecommunication towers having associated local servers, using propagation of identification of items of high demand data at a regional or other geographic level, the computer program product comprising:
one or more computer-readable, tangible storage devices;
program instructions, stored on at least one of the one or more storage devices, to receive at least one request within a region for an item of data made by a user device to a local server associated with a telecommunication tower within the region;
program instructions, stored on at least one of the one or more storage devices, to determine if the request is for an item of high demand data comprising
program instructions to compare a number of requests for the item to a first threshold and to a second threshold greater than the first threshold;
if the number of requests for the item requested by the user device exceeds the first threshold, program instructions to identify the item as high demand data; and
if the number of requests for the item requested by the user device exceeds the second threshold, program instructions to identify the item as second threshold high demand data;
if the item is identified as high threshold data, program instructions, stored on at least one of the one or more storage devices, to instruct the local servers within the region to cache the item of data; and
if the item is identified as second threshold high demand data, program instructions, stored on at least one of the one or more storage devices, to send an indication to at least one centralized server in an adjacent region, such that the centralized server in the adjacent region causes the local servers within the adjacent region to cache the item of data.

10. The computer program product of claim 9, in which the program instructions to send an indication to at least one centralized server in an adjacent region comprises program instructions to send an indication to at least one centralized server in all adjacent regions.

11. The computer program product of claim 9, wherein the item is a file, image or video.

12. The computer program product of claim 9, wherein the program instructions are run on a centralized server.

13. The computer program product of claim 9, wherein the item identified as second threshold high demand data has a cache life span dependent on a number of requests for the item by user devices.

14. The computer program product of claim 9, wherein if requests for an item of data identified as second threshold demand data is below a determined number, the item of data identified as second threshold demand data is purged from the local servers.

15. A computer system for predictive caching for telecommunication towers having associated local servers, using propagation of identification of items of high demand data at a regional or other geographic level, the computer system comprising:
one or more processors, one or more compute-readable memories and one or more computer-readable, tangible storage devices;
program instructions, stored on at least one of the one or more storage devices for execution by at least one of the one or more professors via at least one of the one or more memories, to receive at least one request within a region for an item of data made by a user device to a local server associated with a telecommunication tower within the region;
program instructions, stored on at least one of the one or more storage devices for execution by at least one of the one or more professors via at least one of the one or more memories, to determine if the request is for an item of high demand data comprising
program instructions to compare a number of requests for the item to a first threshold and to a second threshold greater than the first threshold;
if the number of requests for the item requested by the user device exceeds the first threshold, program instructions to identify the item as high demand data; and
if the number of requests for the item requested by the user device exceeds the second threshold, program instructions to identify the item as second threshold high demand data;
if the item is identified as high threshold data, program instructions, stored on at least one of the one or more storage devices for execution by at least one of the one or more professors via at least one of the one or more memories, to instruct the local servers within the region to cache the item of data; and
if the item is identified as second threshold high demand data, program instructions, stored on at least one of the one or more storage devices for execution by at least one of the one or more professors via at least one of the one or more memories, to send an indication to at least one centralized server in an adjacent region, such that the centralized server in the adjacent region causes the local servers within the adjacent region to cache the item of data.

16. The computer system of claim 15, in which the program instructions to send an indication to at least one centralized server in an adjacent region comprises program instructions to send an indication to at least one centralized server in all adjacent regions.

17. The computer system of claim 15, wherein the item is a file, image or video.

18. The computer system of claim 15, wherein the program instructions are run on a centralized server.

19. The computer system of claim 1, wherein the item identified as second threshold high demand data has a cache life span dependent on a number of requests for the item by user devices.

20. The computer system of claim 1, wherein if requests for an item of data identified as second threshold demand data is below a determined number, the item of data identified as second threshold demand data is purged from the local servers.
